(19) United States
(12) Patent Application Publication
(10) Pub. No.: US 2005/0015027 A1
(43) Pub. Date: Jan. 20, 2005

(54) Portable body-felt vibration system

(76) Inventor: Yasuji Kojima, Tokyo (JP)

Correspondence Address: Yasuji Kojima, 12-1 Denenchofu- Minami, Ota-ku, 145-0076, JP

(21) Appl. No.: 10/288,671

(22) Filed: Nov. 7, 2002

(30) Foreign Application Priority Data
Mar. 13, 2002 (JP) P2002-116845

(51) Int. Cl. A61H 23/00

(52) U.S. Cl. 601/57; 601/49

(57) ABSTRACT

The present invention relate to a body-felt vibration system which comprises a vibration transmitting cushion that is structured with elastic and long-lasting materials such as polyurethanes and comprising a transducer that amplifies and transmits low frequency source sounds. The cushion can be used on a regular body support gear such as a bed and chair and used as a body-felt vibration system. The features of the cushion also allows more convenient use than existing systems as well as more efficient use of vibrations generated with a transducer.

### BACKGROUND OF THE INVENTION

1. Field of the Invention

This invention relates to a body-felt vibration system having a vibration transmitting member and a transducer that amplifies and transmits low frequency source sounds that have a maximum output in audible region.

2. Prior Art

Different types of body sensory acoustic systems that use a transducer have been developed. For example, at St. Luke's International Hospital in Tokyo, a chair with a built-in transducer is used for music therapy in an artificial dialysis room. At Japan Red Cross North Osaka Blood Center, a bed with a built-in transducer is used during blood taking so that a blood donor can experience body sensory sounds. Morita Corporation in Tokyo has been developing a dental chair with a built-in body sensory acoustic device. These types of body-felt vibration systems with a fixed transducer have a longer manufacturing time and a higher manufacturing cost because a transducer must be built in a body support component such as a bed or a chair. When this type of body-felt vibration system is used at a hospital as a regular bed or a chair, there is a risk that the transducer is mistakenly used for a patient who must avoid vibration such as a pregnant woman since a transducer is fixed in a body support component.

As described above, the most of the body-felt vibration systems in prior arts are not portable and can not be used at other places easily. However, there are a few examples of portable body-felt vibration systems. At Yokohama municipal hospital, a bed-pad type body sensory acoustic device for medical use is developed. When it is used on a mattress, a regular bed can be used as a body sensory acoustic bed. Akira Komatsu also has invented a portable body sensory acoustic device which is placed on a chair. (U.S. Pat. No. 5,442,710) These systems still have problems. With these systems, we do not obtain efficient vibration from a transducer because there is no guide to lead a user's backbones to the top portion of the transducer. In addition, in the prior arts there is no support to maintain the backbone on the right position; therefore, the efficient vibration is not obtained when the backbone is out of the right position.

There have been other types of problems in the body sensory acoustic systems of prior arts. First of all, the vibration generated with a transducer in prior art is often reduced since the back end of the transducer (the opposite side that the transducer faces to a user's backbone) touches the surface of the body support component such as a bed and a chair. In this case, the vibration is transmitted to the body support component, and vibration generated by the transducer is not used efficiently.

Secondly, the part which covers a transducer and which is placed between a user's backbones and the transducer is easily worn out because of frictions. However, there is no cost-effective solution for the worn-out.

Thirdly, since the body-felt vibration systems in prior arts are invented for stand-alone use, there has not been a controller which adjusts a vibration-volume of multiple body sensory acoustic systems. The vibration-volume of body-felt vibration systems must be adjusted separately, and it was inconvenient at a place such as a hospital where multiple body sensory acoustic systems are used simultaneously.

### SUMMARY OF THE INVENTION

This invention is intended to provide an improved portable body-felt vibration system which may be used on a different type of body support gear including a regular bed and a chair. By providing the portable body-felt vibration system, the problems associated with fixed systems such as high production costs, longer production time, misusages by patients and cumbersome control of multiple systems will be solved. The improved portable system will also provide more convenient usage, more efficient vibration and less maintenance costs than existing systems.

Therefore, objects of this invention include to provide a portable rough-rectangular vibration-transmitting cushion; to provide a guide that lead a user's backbones to the transducer's vibration transmitting plate; to reduce vibrations that are transmitted to a body support gear such as a chair back; to support a user's back to remain in a proper position; to separate a vibration-transmitting plane from other part of the vibration-transmitting surface and use different materials for the plane from the materials for other surface; to eliminate stitches over a vibration-transmitting plate of a transducer; to provide a control unit that can control multiple vibration output devices and sound output devices; and to provide a configuration of the cushion that can easily identify the mounting direction of the cushion.

### BRIEF EXPLANATION OF THE DRAWINGS

FIG. 1 is a perspective view that explains the first embodiment of this invention.

FIG. 2 is a cross sectional schematic drawing that explains the first embodiment of this invention.

FIG. 3 is a side view that explains the first embodiment of this invention

FIG. 4 is a front view that explains the second embodiment of this invention

FIG. 5 is a cross section that explains the third embodiment of this invention.

FIG. 6 is a diagram that explains the fifth embodiment of this invention.

FIG. 7 is a diagram that explains the seventh embodiment of this invention.

FIG. 8 is a diagram that explains the eighth embodiment of this invention.

FIG. 9 is a diagram that explains the ninth embodiment of this invention.

### DETAILED DESCRIPTION OF THE PREFERRED EMBODIMENT

### The First Embodiment

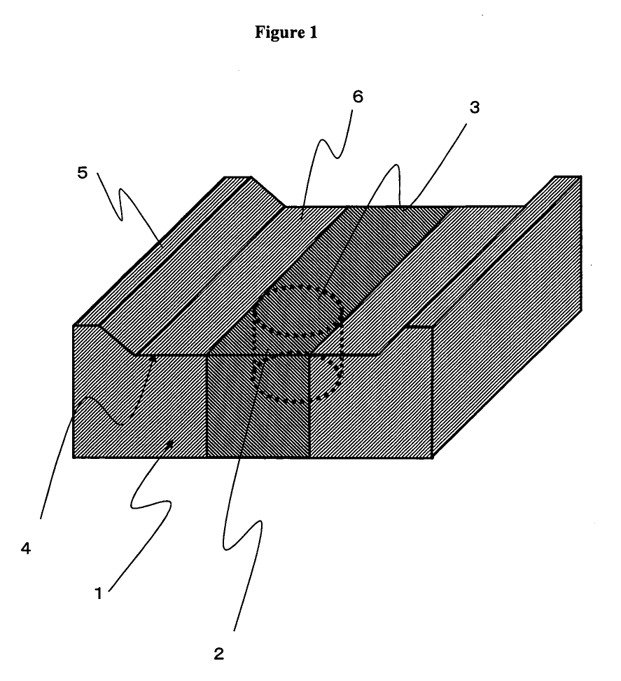

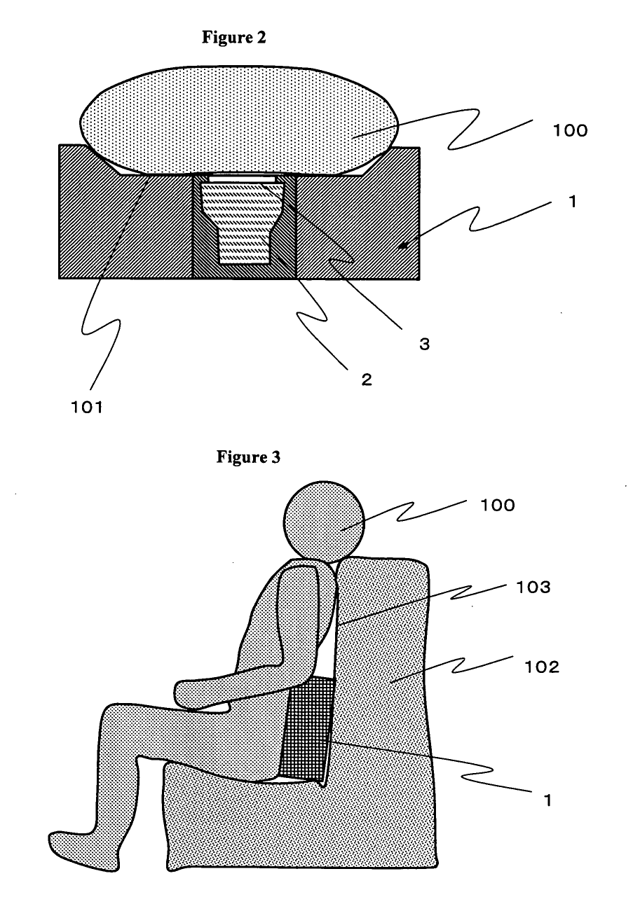

The first embodiment is explained with FIG. 1. FIG. 1 describes a waist cushion 1 of the body-felt vibration system of this invention. A transducer 2 is installed in a center part of said cushion and surrounded with polyurethane rubber. Outer shape of the cushion is a rough rectangle. The waist cushion has a vibration transmitting surface 4 that is connected to a vibration transmitting plate 3 of said transducer. The two facing edges of the vibration transmitting surface 4 are taller than other area creating banks 5. The vibrating plate 3 of said transducer is installed on hollow area 6 in the center of the cushion. When this device is used, said banks are placed on a user's back. The vibrating plate 3 in the hollow 6 is designed to be applied close to the user's backbones. The banks 5 guide the vibrating plate to the backbones of a user. FIGS. 2 and 3 describes how a user 100 is using the waist cushion 1. FIG. 2 is an image seen from above describing that the user is sitting in a chair leaning against the cushion 1. In FIG. 2, the upper part is the stomach of the user 100, and the lower part is the back 101 of the user. The user is sitting against the waist cushion 1, and the vibration plate 3 of the transducer 2 is applied closer on the center of the user's back 101. The back end of the transducer 12 is installed in the inside of back end of said cushion 13. Although the back end of the cushion is placed against the chair back, the back end of the transducer doest not reach to the chair end since there is a distance between the transducer back end and the cushion back end. Therefore, the vibration from the transducer does not damage the chair back, and the frequency characteristics of the vibrations are not deteriorated from the contact between the transducer and the chair back. FIG. 3 is an image from a side describing that the user 100 is sitting in a chair 102 leaning against the chair back 103. The waist cushion 1 is placed between the user's back 101 and the chair back 103. Because of this waist cushion 1, the user is leaning more than the chair back.

### The Second Embodiment

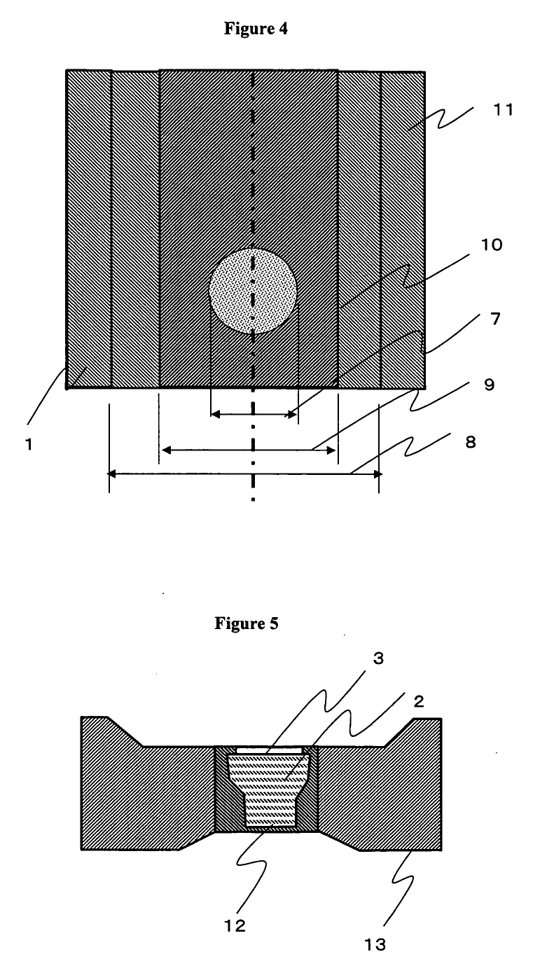

The second embodiment is explained with FIG. 4. This is an example of different material usage for the belt-shaped vibration transmitting plane 9 from other part. In this example, the vibration transmitting plane 9 is wider than the vibration plate width 7 and narrower than the hollow width 8. The vibration transmitting plane 9 is connected with other surrounding parts 11 on the stitches 10. The vibration plate 3 transmits strong vibrations; therefore, if stitches are over the vibration plate, the stitches are more likely to be worn out. However, in this example, the deterioration is reduced since there is no stitch over the vibration plate. In addition, if there are stitches over the vibration plate, the stitches create an uneven surface, which is pressed against the user's back, and deteriorate the user's usage feeling. The stitches 10 in this invention are not in the area where the user's backbones are pressed. Therefore, the user's usage feeling is satisfactory in the system of this invention. Furthermore, the belt-shaped part is made with more elastic and thinner material than the materials used for other surrounding part 11. The parts connected to the belt-shaped part are made with firm and frictional material. The combination of the two different materials reduces the loss of vibration transmitted from the transducer to the user's backbones. The combination also supports the cushion to stay in the chair.

### The Third Embodiment

This is an example of using different colors for the belt-shaped part and other surrounding parts in the second embodiment. For instance, dark blue is used for the belt-shaped part, and light blue is used for the surrounding part. Light color is used for the surrounding part so that the chair and the user's clothes do not get color from the surrounding part. The belt-shaped part is made with thin material; therefore, dark color is used to prevent the transducer and the cushion structures not to be seen easily.

### The Fourth Embodiment

The fourth embodiment is an example that the transducer's back end 12 does not go beyond the back end of the cushion 13. FIG. 5 is a cross section that shows the example. In FIG. 5, the vibration plate 3 of the transducer 2 is installed in the hollow 6. In addition, the back end of the transducer is about 1 mm inside of the cushion's back end. In this way, the back end of the transducer does not reach to a body support component, and generated vibrations are not lost by being transmitted to the body support component.

### The Fifth Embodiment

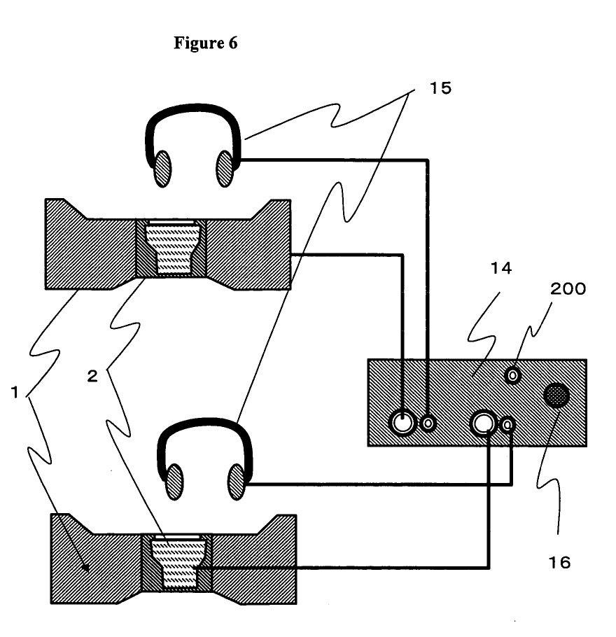

The fifth embodiment is explained with FIG. 6. This is an example of a single adjustment variable resistor that controls two waist cushions. In this example, there is an output control unit 14 that controls two waist cushions which have a transducer 2. The control unit also controls two headphones 15 that are used to listen to music. Therefore, in this example, there are four output devices, two transducers and two headphones. In the control unit, there is an adjustment variable resistor 16 that control volumes of the four output devices. This adjustment variable resistor 16 controls output ratios between the sound volume of the headphones and the vibration volumes of the transducer. Separately, only the sound volume of the headphone 15 is controlled with the volume control of the music playing device that is connected through sound-input jack 200. A music player such as a CD player is used to output source sound to the adjustment variable resistor. There is a case that said adjustment variable resistor is fixed at a certain level and sound volume is set low at the music playing device, and the vibrations transmitted from the transducer are also weak. In this situation, if said adjustment variable resistor's setting is changed to amplify the source sound more and output stronger vibration, then we obtain a combination of strong vibrations and low volume music sounds. The opposite combination is also possible. If the adjustment variable resistor is set to output weak vibrations, we obtain a combination of weak vibrations and high volume music sounds.

In this example, the default output levels of the two headphones are set at the same level, and the default output levels of the two transducers are also set at the same level. (Outputs levels from these devices are controlled by only the adjustment variable resistor and the sound volume controller of the music playing device.) The sound-input jack, which is used to transfer sound data from a music playing device to the output control unit, is made adaptable to the both Line Output and Phone Output. The jack's configuration and the inputting characteristic are adaptable to any kind of audio video devices, computers and mobile phones. Some transducers change its output frequency range. Upper limit frequency of standard transducers' amplifier band is set at 150 Hz. If this upper limit is extended, the transducer outputs audible sounds just like ordinary loud speakers. Thus the transducer serves as a loud speaker. If the standard upper limit of 150 Hz is used, the audible sounds are outputted from only loud speakers but not from the transducers. In this case, high quality sounds are outputted from the loud speakers, and high quality vibrations are transmitted from the transducers.

### The Sixth Embodiment

This is also an example of using an adjustment variable resistor. Similar to the fifth embodiment, source sound volume is set at the music playing device, and the source sound volume is used as the sound volume for the headphones. The adjustment variable resistor controls the output ratios between the source sound output level and the vibration volume of the transducer. In a case that source sound volume is low, the vibration also becomes weak. However, if the adjustment variable resistor is set to increase vibration, we obtain stronger vibrations from the low volume source sounds. It is also possible to obtain weaker vibrations from a high volume source sounds by changing the setting of the adjustment variable resistor. In this case, frequency of the vibration is between 16 Hz and 150 Hz.

### The Seventh Embodiment

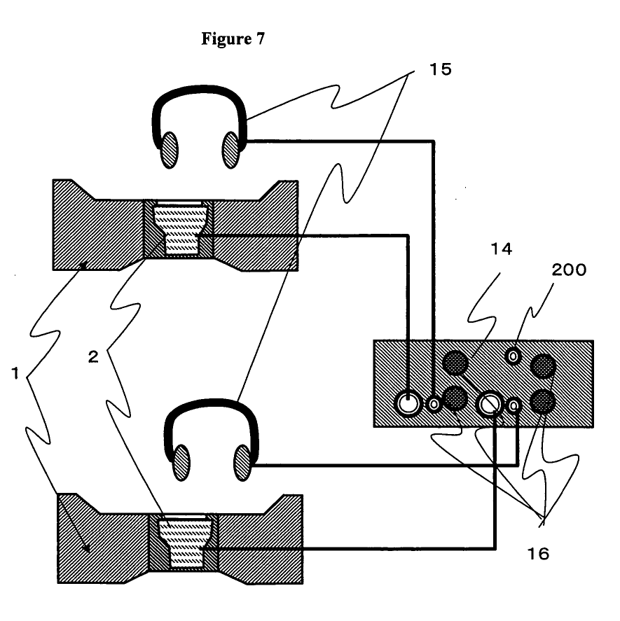

The seventh embodiment is explained with FIG. 7. This is an example of using multiple adjustment variable resistors 16. In FIG. 7, a control unit 13 controls two transducers 2 and two headphones 15 by using four adjustment variable resistors 16. In this case, even if the source sound volume is fixed at the music playing device, the both volumes of music sounds and vibrations are controlled with the control unit 13 at hand.

### The Eighth Embodiment

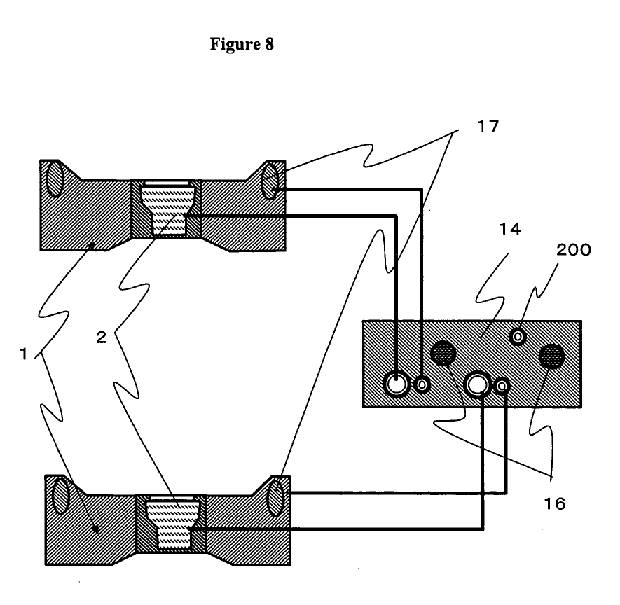

The eighth embodiment is explained with FIG. 8. This is an example of waist cushion that has two loud speakers 17 as well as a transducer 2. Other members are the same as in FIG. 6 and 7. Therefore, the system has the same effect described in the embodiments six and seven without using headphones.

### The Ninth Embodiment

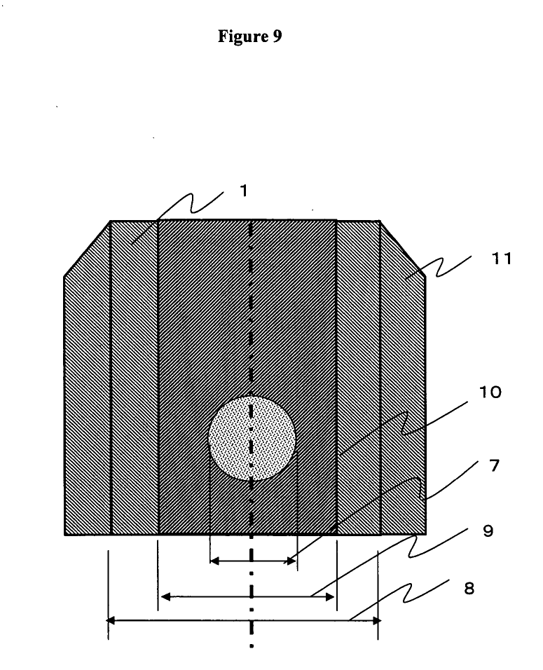

The ninth embodiment is explained with FIG. 9. This is an example of at least one upper corner of the rectangular cushion is trimmed. In this example, two upper corners where a user's upper back are supported are trimmed. The trimmed shape helps to identify the mounting direction of said waist cushions easily. The cushion also has a shape that lower part, which placed on the chair, is flat and wider than the upper part when the cushion is placed against the chair back so that the cushion is placed more stably and applied more closely to the buttock of a user.

1. A body-felt vibration system which comprises a vibration transmitting cushion that is structured with elastic and long-lasting materials such as polyurethanes and comprising a transducer that amplifies and transmits low frequency source sounds.

2. A body-felt vibration system according to claim 1, wherein said vibration transmitting cushion is shaped as a rough rectangle and has a vibration transmitting surface that is connected to a vibration transmitting plate of said transducer.

3. A body-felt vibration system according to claim 2, wherein at least one upper corner of said rectangle cushion is trimmed.

4. A body-felt vibration system according to claim 1, wherein a pair of edges of said vibration transmitting surface rises higher than any other area of said vibration transmitting surface.

5. A body-felt vibration system according to claim 1, wherein said cushion's vibration transmitting surface is shaped to fit to a figure of a user's back, and the vibration transmitting of said vibration transmitting plate is applied to the backbones of the user.

6. A body-felt vibration system according to claim 1, wherein the back end of the transducer which is comprised in said cushion is installed in the inside of said cushion's back end.

7. A body-felt vibration system according to claim 1, wherein there is no stitch on the vibration transmitting plane which covers said vibration transmitting plate.

8. A body-felt vibration system according to claim 6, wherein said vibration transmitting plane is belt-shaped and different in colors, materials and weaving directions from the materials to cover other surface areas of the cushion.

9. A body-felt vibration system which comprises a plurality of vibration transmitting cushions and a single output control unit.

10. A body-felt vibration system according to claim 8, wherein said output control unit comprises a single adjustment variable resistor.

11. A body-felt vibration system according to claim 8, wherein said output control unit comprises plurality of adjustment variable resistors for each output device.

12. A body-felt vibration system according to claim 8, said cushion is equipped with loud speakers.
